(19) United States
(12) Patent Application Publication
(10) Pub. No.: US 2004/0190468 A1
(43) Pub. Date: Sep. 30, 2004

(54) Group communication in a communication network

(76) Inventor: Jaakko Saijonmaa, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/441,942

(22) Filed: May 21, 2003

(30) Foreign Application Priority Data
Mar. 24, 2003 (FI) 20030429

(51) Int. Cl. H04L 12/56

(52) U.S. Cl. 370/312

(57) ABSTRACT

A group communication gateway is provided between a direct-mode network and a packet based group communication service in a cellular network. The communication gateway communicates with the packet based group communication service over a cellular air interface and with direct-mode terminals over a direct-mode air interface for interchanging group packet control signalling and group packet speech and/or data traffic, thereby enabling the direct-mode user terminals to participate in a packet based cellular group communication. The group communication gateway relays group attachments/detachments, handles group speech item reservations, and forwards group packet speech and data traffic between the direct mode network and the packet based group service in the cellular network.

### BACKGROUND OF THE INVENTION

1. Field of the Invention

The present invention relates to group communication in communication networks.

2. Description of the Related Art

One special feature offered in mobile communications systems is group communication. The term “group”, as used herein, refers to any logical group of three or more users for participating in the same group communication, e.g. a speech call. The same user may be a member of more than one communication group. Often the members of the communication group belong to the same organization, such as the police, the fire brigade, a private company, etc. Also, typically, the same organization has several separate groups, i.e. a set of groups.

Conventionally group communication has been available only in trunked mobile communications systems, such as Professional Radio or Private Mobile Radio (PMR) systems, such as TETRA (Terrestrial Trunked Radio), which are special radio systems primarily intended for professional and governmental users, such as the police, military forces, oil plants.

Group communication with a push-to-talk feature is one of the essential features of any PMR network. Generally, in group voice communication with a “push-to-talk, release-to-listen” feature, a group call is based on the use of a pressel (PTT, push-to-talk switch) in a telephone as a switch: by pressing a PTT the user indicates his desire to speak, and the user equipment sends a service request to the network. The network either rejects the request or allocates the requested resources on the basis of predetermined criteria, such as the availability of resources, priority of the requesting user, etc. At the same time, a connection is established also to all other active users in the specific subscriber group. After the voice connection has been established, the requesting user can talk and the other users can listen on the channel. When the user releases the PTT, the user equipment signals a release message to the network, and the resources are released. Thus, the resources are reserved only for the actual speech transaction or speech item, instead of reserving the resources for a “call”.

The group communication is now becoming available also in public mobile communications systems. New packet-based group voice and data services are being developed for cellular networks, especially in the GSM/GPRS/UMTS network evolution. In some approaches, the group communication service, and also a one-to-one communication, is provided as a packet-based user or application level service so that the underlying communications system only provides the basic connections between the (i.e. IP connections) group communications applications in the user terminals and the group communication service. The group communication service can be provided by a group communication server system while the group client applications reside in the user equipments or terminals. Examples of this approach are disclosed in co-pending U.S. patent applications Ser. Nos. 09/835,867; 09/903,871; and 10/160,272; and in WO 02/085051. When this approach is employed for the push-to-talk communication, the concept is also referred to as a push-to-talk over cellular (PoC) network.

In trunked PMR networks and in TETRA also direct-mode services are available but the standards are applying circuit-based voice channels over the radio interface. Direct-mode operation relates to a mode of simplex operation where radio units can communicate by using radio frequencies (direct mode channels) which are not controlled by the network, that is without the intervention of any base station. Also repeaters may be used for transmitting direct mode communication between radio units in places where radio coverage is not sufficient due to buildings or other obstructions. In the TETRA system such “direct mode repeater” usually is mobile, for example located on top of or in a vehicle.

Methods for enabling convenient communications between mobile wireless devices have sparked intense interest in creating new network protocols that can reduce or eliminate entirely any constraining dependence on external routers. Several packet-based shared channel (WLAN, Bluetooth, multihop radio) radio communications systems have been proposed and developed, working independently (such as infrastructure-less, autonomic, stand-alone ad hoc networks) or with the aid of the legacy communication networks such as mobile and IP networks (such as semi-infrastructured, operator-aided ad hoc networks). These new network protocols fall under the general heading of “ad hoc networking”. Because the nodes of the ad hoc network are connected by wireless links forming a mesh of connections, this new technology is also often referred to as “ad hoc mesh networking”. Ad hoc networking is created only as needed and not as part of any general administrative function. The basic concept is simple: when a number of mobile devices (also referred to as nodes) gather together anywhere (e.g. in a place where no infrastructure is available), the devices themselves must set up and maintain communications. If two nodes are not within communication range, intermediate nodes may have to forward data traffic. Therefore, ad hoc networks are typically considered as multihop networks. Since all these devices may be portable or mobile, the network topology may change dynamically. Every node may act as a router in a wireless mobile environment.

Normal, connectionless IP (Internet Protocol) services typically form the traffic over ad hoc networks. This means that the system uses normal IP, and that the special problems that come along with ad hoc networking have to be solved on top of IP. Using IP also means independence from the network technology. An ad hoc network can be set up using, e.g. IEEE 802.11, Hiperlan, or Bluetooth. Internet Engineering Task Force (IETF) has established a working group called Mobile Ad hoc Networks (MANET) on the subject of mobile ad hoc networking. MANET working group is standardizing routing protocols for ad hoc networks. Examples of the routing protocols include Ad hoc On-demand Distance Vector routing protocol (AODV), Dynamic Source Routing protocol (DSR), and Cluster Based Routing Protocol (CBRP). More information on MANET is available from RFC 2501, and at the IETF home site http://ietf.org/html.charters/manet-charter.html.

Cellular based circuit and packet networks as well as push-to-talk services over those cellular networks lack capabilities for efficient direct communications. Service is available only under the coverage of the cellular network. In remote areas and inside buildings the cellular coverage may not be available. A hot-spot capacity for group data and push-to-talk service in cellular networks may be limited due to the lack of multicasting features in cellular networks.

Thus, there is a need for a better packet based service availability and capacity for group communications especially in hot-spots of a large number of users in a restricted area and also in remote areas of non-existent or low cellular network coverage. This is especially important in public safety and security communications.

### SUMMARY OF THE INVENTION

The invention seeks to improve the availability and capacity for packet based group communications, especially in hot-spots of a large number of users in a restricted area.

The present invention provides a group communication gateway between a direct mode network and a packet based group communication service in a cellular network. The communication gateway communicates with the packet based group communication service over a cellular air interface and with direct-mode terminals over a direct-mode air interface for interchanging group packet control signalling and group packet speech and/or data traffic, thereby enabling the direct-mode user terminals to participate in a packet based cellular group communication. The group communication gateway may provide one or more of the following functions: 1) relays group attachments/detachments, 2) handles group speech item reservations, 3) forwards group packet speech and data traffic between the direct mode network and the packet based group service in the cellular network. Effectively, the gateway hides the local direct-mode network signalling and the direct-mode air interface from the cellular network and emulates a multitude of terminals of the direct-mode network to the cellular network. In the similar way, the gateway effectively hides the cellular network from the direct mode network and behaves as multiple terminals towards the direct mode network.

The invention improves the capacity for the packet-based group communication in a cellular system, especially in hot-spots of a large number of users in a restricted area and also in remote areas of non-existent or low cellular network coverage. A number of users can establish a local direct-mode network within or outside the coverage of the cellular network in accordance with a specific direct-mode communication technique employed, and utilize the packet-mode group communication service of a cellular network through the group communications gateway, while cellular air-interface resources are required only for the gateway. Thus, the cellular resources required correspond to the capacity requirement of one or few cellular terminals, while the group communication service can be provided to a high number of users in the restricted hot-spot area. The invention also allows the users of direct mode network to communicate with any other members of the group, such as conventional cellular terminals or users in other direct-mode networks. The invention also extends the cellular group communication service to users in remote areas of non-existent or low cellular network coverage, since only the gateway must be within the cellular network coverage while the additional coverage is obtained by the direct-mode network technique, e.g. employing multihop communication. Also the signalling and traffic load is decreased, when the communication of multiple users is carried out through the gateway in a centralized manner.

On the other hand, from the direct-mode network point of view, the invention provides the users with the packet-mode group communication service that may not be even available in a specific direct-mode network, or extends the internal group communication service of the direct-mode network to be part of a cellular packet-mode group communication service.

### BRIEF DESCRIPTION OF THE DRAWINGS

In the following the invention will be described in greater detail by means of embodiments thereof and with reference to the accompanying drawings, in which:

FIG. 1 illustrates an example of general architecture of a communication system having a packet-based group communication service (GCS), a cellular access system, and a direct-mode-network according to the present invention;

FIG. 2 illustrates an embodiment wherein a packet mode group communication service is provided with a server system overlying the cellular core and radio access networks;

FIG. 3A, 3B, and 3C illustrate examples of ad hoc network topologies;

FIG. 4 shows a generic functional block diagram for a gateway according to an embodiment of the invention;

FIGS. 5 and 6 illustrate examples of protocol stacks in the communication system shown in FIG. 2; and

FIG. 7 is a signalling diagram illustrating examples of different group communications procedures that may be carried out in various embodiments of the invention.

### DETAILED DESCRIPTION OF THE PREFERRED EMBODIMENTS

The present invention is applicable to any communication system allowing packet based group communication. The communication may include data communication, audio communication, video communication, multimedia communication, messaging, such as short messaging, etc.

Example of the general architecture of a communication system implementing the packet-based group communication according to the present invention is illustrated in FIG. 1.

Conceptually, there are three main architectural hierarchies that can be observed in FIG. 1. The most upper level is a packet-mode application domain, i.e. the packet-based group communication service (GCS) 21. The middlemost level called access domain includes different radio accesses that overlay the stand-alone direct-mode networks, providing infrastructure-oriented radio connection for user terminals, such as cellular terminals 1, 2 and 3, and for the group communication gateway 23 according to the present invention, over the (cellular) air interface of the access system 22. The most lowest part, direct-mode domain, is the actual direct-mode network basis, which provides peer-to-peer, multihop and/or multi-branch radio communication, including both infrastructure-less and infrastructure-oriented radio communication for direct mode user terminals, such as terminals DT1, DT2, and DT3, over a direct-mode air interface.

The packet-based group communication service may be a user or application level service so that the underlying communication system only provides the basic connections (i.e. IP connections) between the applications in the user terminals between the group communication applications in the group communication service and the peer applications in the user terminals CT1-CT3, a group communications gateway 23, and the user terminals DT1-DT3. In this approach, the group communication service (GCS) may be provided by a group communication server application while the client applications may reside in the user terminals and the group communication gateway 23.

The direct-mode network 24, as used therein, refers to any direct-mode technique allowing direct communication between direct-mode user terminals. The direct-mode network may be based on a shared radio channel circuit, a packet-based communication, or a multi-hop direct-mode packet network consisting of possibly several relay nodes to the terminal. The direct-mode network does not necessarily have any fixed infrastructure support, neither a common group server node or functionality. In an embodiment of the invention, the direct-mode network is established by TETRA direct-mode terminals in accordance with the TETRA specifications. In some embodiments of the invention, the direct mode network is an ad hoc network that is based on any packet based shared channel radio communication technique, such as wireless local area network (WLAN), Bluetooth, MANET (mobile ad hoc networks), etc.

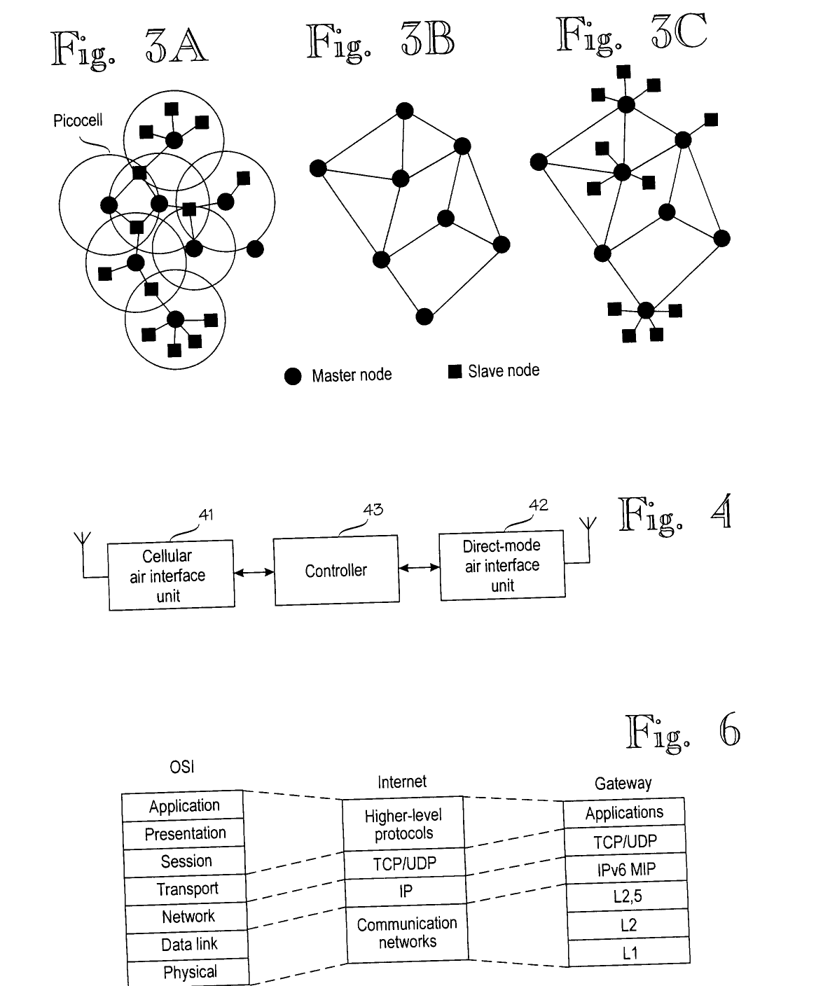

A Bluetooth system provides a point-to-point connection, or a point-to-multipoint connection using star linked topology, in which all the traffic goes through a master node. In a kind of Bluetooth cell that is called a piconet, the channel capacity is shared among several units, of which only seven can be active at a time. In addition, a master in one piconet can be a slave in another piconet providing scatternet connectivity via packet switching. A scatternet is thus formed from at least two connected piconets. The scatternet network is illustrated in FIG. 3A. More information about Bluetooth can be found at www.bluetooth.com.

The current IEEE 802.11 wireless LAN standard supports also the ad hoc network configuration wherein nodes are brought together to form a network “on the fly”. There are no fixed nodes, so the nodes take turns as the master of the network with the others being slaves. The nodes communicate directly with each other on a peer-to-peer level sharing a given self coverage area of the master. The nodes are sharing a single radio channel. Multihop connectivity can be attained via nodes acting as repeaters of the master.

Still a further ad hoc network topology is the peer-to-peer communication between equal nodes as illustrated in FIG. 3B. These nodes are each equally capable of forwarding traffic, and the communicating nodes can have any topology. A further development of this topology further comprises “stupid” slave nodes that work under the peer-to-peer level, e.g. wireless accessories like headphones. This topology is illustrated in FIG. 3C. The nodes may be sharing a single radio channel, but a multiple of radio links sharing a set of radio channels forms a more effective environment for a large-scale ad hoc network.

The routing protocols employed in the mobile ad hoc networks may include AODV, DSR, or CPRV, for example.

It should be appreciated that the basic idea of the present invention is independent of the specific direct-mode or ad hoc network technique, topology, or protocol employed. The technologies, topologies and protocols are only examples.

Referring to FIG. 1, a direct-mode network 24 includes a group communication gateway 23 according to the invention. The gateway 23 provides interworking with the overlying access system 22, e.g. the cellular access network. To that end, the gateway 20 must have means, such as a cellular air interface unit 41 and a direct-mode air interface unit 42 shown in FIG. 4, for communicating with the access system 22 using the air interface technology of the access system, and for communicating within the direct-mode network 24 using the direct-mode air interface technology, respectively. The cellular radio access network 22 may be based on any second or third or further generation mobile radio access, such as GSM base station system (BSS), including GPRS (General Packet Radio Service) and EDGE (Enhanced Data Rate for Global/GSM Evolution), and WCDMA (Wideband Code Division Multiple Access). In this respect, the gateway 23 acts as a conventional GSM or WCDMA terminal. The RAN, which basically consists of group of base stations and base station controllers, is responsible for handling radio resource management, handling the overall control of radio connection, radio transmission and many other functions specified in the corresponding standards for those radio access systems. Therefore, the cellular access domain 22 also coordinates the radio resource of the gateway 23 as far as the traffic relaying over the cellular network is concerned. As the gateway 23 according to the preferred embodiment of the invention hides the direct mode terminals behind the gateway from the cellular network, the cellular network may only form a bit pipe (s) for the traffic from/toward the gateway 23.

The radio technology employed between the direct-mode network nodes naturally depend on the specific direct-mode technique in each case. The Bluetooth radio operates in the frequency bandwidth of 2.4-2.48 GHz., enabling a range of 10-100 metres. The radio hardware can be implemented by means of a commercial single-chip circuit suitable for utilization as an integrated part of small size devices, such as mobile phones. If the direct-mode network is based on TETRA direct-mode operation (DMO), the direct-mode air interface unit can be embodied as a TETRA DMO terminal, whereby the gateway 20 is a kind of cellular/TETRA DMO dual-mode radio unit provided with additional gateway functionality according to the present invention. The direct-mode network mobility can be based on a local shared radio channel, WLAN, Bluetooth, IP multicasting or more advanced dynamic ad hoc network based routing algorithms as proposed for example in ITF MONET/MANET proposals. All such functionality is represented by the controller block 43 in the FIG. 4.

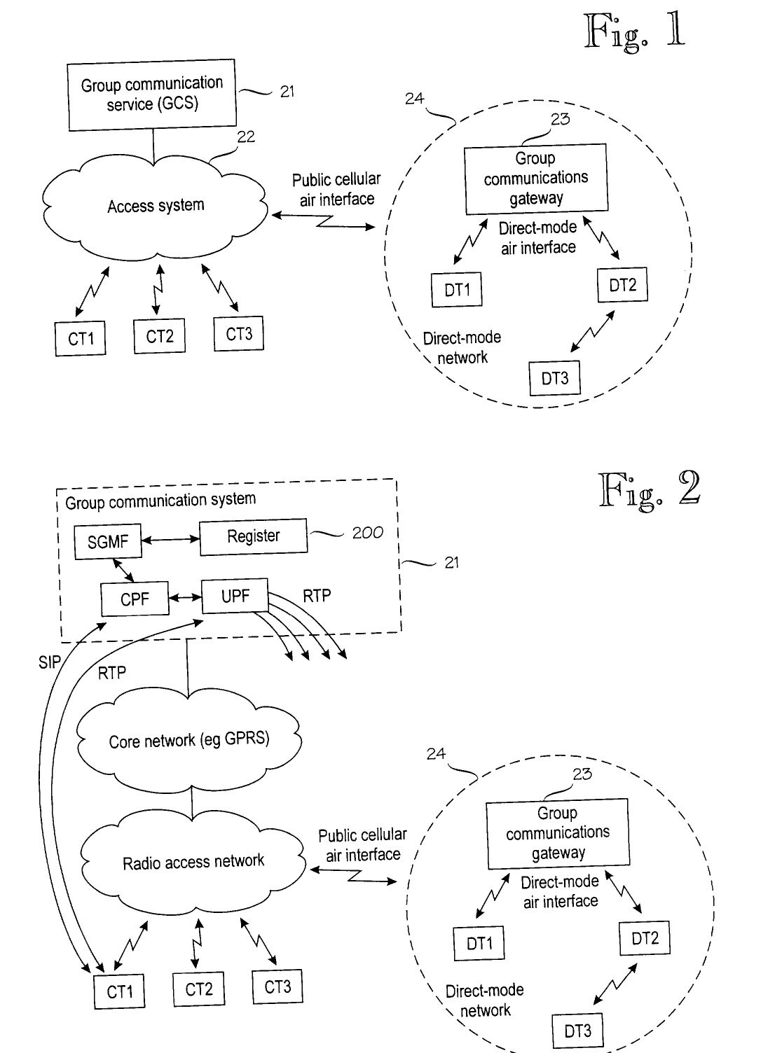

FIG. 2 illustrates an example wherein a packet mode group communication service is embodied with a server-based group communication system 21 having different control-plane and user-plane logical entities serving the subscribers. The basics of this concept and examples of the architecture and different implementations are illustrated in more detail in the co-pending U.S. patent applications Ser. Nos. 09/835,867; 09/903,871; 10/160,272; and 09/903,871; and in the PCT application WO 02/085051, which are incorporated herein by reference. The subscriber transmissions are proxied and forwarded by these server entities, which do not allow direct end-to-end transmissions between the subscribers. It should be appreciated that control-plane functions (CPF) and user-plane functions may also be within the underlying access network(s), providing a top protocol layer for the access network.

In FIG. 2, a packet based group communication system 21 is provided on top of the mobile network in order to provide group communication services to the cellular user terminals CT through the communication system. The group communication system 21 may be embodied as a server system. Conceptually, the group communication server system may comprise control-plane functions CPF and user-plane functions UPF providing packet mode server applications which communicate with the group communication client application(s) in the user terminals CT over the IP connections provided by the communication system. This communication includes signalling packets and voice or data communication packets. The CPF function is responsible for control-plane management of the group communication. This may include, for example, managing the user activity and creation and deletion of logical user-plane connections with an appropriate control protocol, such as Session Initiation Protocol (SIP). The user may also perform group attachment and group detachment with the CPF using control signalling, e.g. the SIP protocol. CPF also carries out user registration and authentication.

The user-plane function(s) UPF is responsible for distribution of the data or speech packets to the user terminals according to their group memberships and other settings. The UPF forwards traffic only between valid connections programmed by the CPF. In case of speech communication, it may be based on voice over IP (VoIP) protocol, and/or Real-time Transport Protocol, (RTP). It should be appreciated that the user-plane operation relating to the data or speech traffic is not described in detail invention. However, the basic operation typically includes that all the data or speech packet traffic from a sending user is routed to the UPF which then delivers the packet traffic to all receiving users in the group using a suitable technique, such as multicasting or multiple unicasting (multi-unicast).

The group communication server system 21 may also include a subscriber and group management function (SGMF) for managing the subscriber and group data. It may also provide specific tools and interfaces needed for subscriber and group provisioning. The system 21 may also include a register 200 for storing all provisioned data in the group communication system.

In an embodiment of the invention, the group communication gateway node 23 has the following functions or any subset thereof: 1) it authenticates and registers the gateway and optionally the direct mode terminals to the group communications service 2) it maps direct mode groups to packet-based group communications service groups, 3) it maps direct mode one-to-one calls to packet-based group communications service calls, 4)it relays group attachments/detachments, 5) handles speech item reservations, 6) routes group packet speech and data traffic between the direct-mode network 24 and the packet based group service 21 in the cellular network 22. The gateway node 23 hides the local direct/multihop network signalling and air interface from the cellular packet based network 22 and emulates, on the application level, a multitude of terminals of the direct mode network to the packet based cellular network. In the similar way, the gateway node 23 hides the packet based cellular network from the direct-mode network and behaves as multiple direct mode terminals towards the direct-mode network.

The gateway node 23 carries out a conversion between the group and member addressing methods of the packet-mode group communication service and the direct-mode network. URL and/or IP based addressing can be used in both networks. Communication sessions can be controlled by SIP (Session Initiation Protocol), H323, QSIG or other proprietary or standard signalling protocols. In case of using SIP, the gateway node 23 may behave as a SIP proxy towards both the group communication service 21 and the direct-mode packet network.

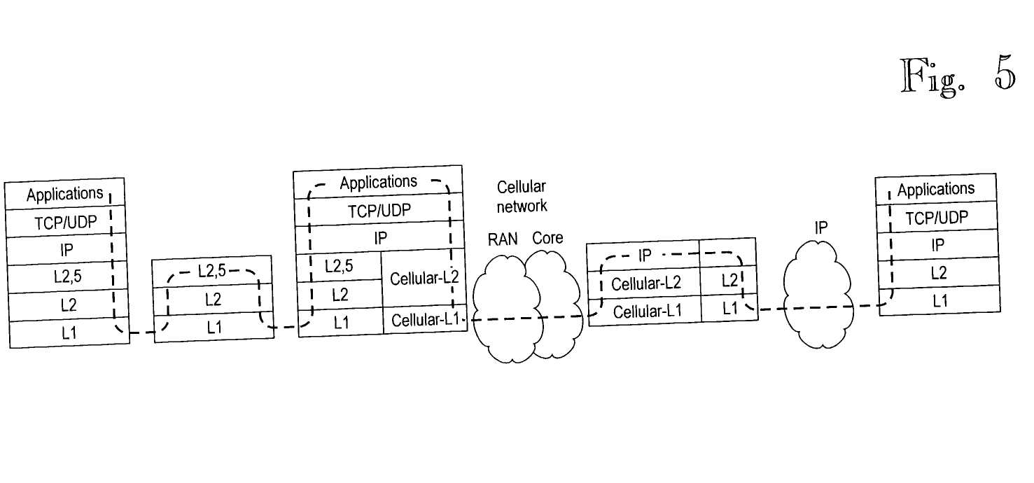

As noted above, the packet-mode group communication service according to the preferred embodiments of the invention is a user or application level service that overlays the communication network level, i.e. the access network, the direct-mode network, and an IP network (such as internet). An example of a protocol stack that can be employed in the architecture of FIG. 2 is illustrated in FIG. 5A. The protocol stack mapping between OSI (open system interconnection) protocol stack, the Internet protocol stack, and the direct mode network protocol stag is illustrated in FIG. 6. The Internet model simplifies the OSI 7-level protocol model into 4 levels. The direct-mode network stack is, in this example, based on the Internet stack but dividing the communication network level to physical layer, link layer and layer 2.5. The layer 2.5 is an extension between network and link layers; implemented to extend the network layer performance by radio quality air level protocols and local addressing for ad hoc communications. It should be noted that the lowest layers of the protocol stack depend on the specific technology used, and the protocol stack shown in FIGS. 5 and 6 is only an example. For example, in TETRA, the protocol stacks defined for TETRA DMO are employed. In cellular and IP networks respective communication network layers L1 and L2 are employed. The purpose of FIG. 5 is only to illustrate an example, explaining how a packet mode data pipe can be established between the server applications in the group communication system 21 and the group communication applications in the node of the direct-mode network (e.g. the gateway and the terminals). It should be appreciated, however, that the data pipe may end at the gateway, and a network-specific communication is applied within the direct mode network. This applies to the TETRA DMO, for example, wherein all the cellular group communication functionality may reside in the gateway 23, and TETRA DMO is used as specified in TETRA DMO standard within the direct-mode network 24, and the gateway 23 extends the TETRA DMO group and individual communications to the cellular groups. The situation of FIG. 5 is most suitable to the case wherein the network 24 is a packet-based direct-mode network in which case part of the packet-mode group communication functionality can reside in the terminals.

In the case there are members of a packet-mode communication group both in the cellular network and in the direct-mode network (some users of both networks attached to a single group in the group communication system 21), the speech item reservation and grant is controlled by the reservation mechanism of the group communication system 21. In the case all (active) group members of the packet mode group communication are in the direct-mode network 24, the speech item reservation and grant may be controlled by the speech item grant mechanism of the local direct mode network.

In an embodiment of the invention a packet-mode group communication agent that controls the speech item reservation within the direct mode network 21 resides in the gateway node 23. In that case, the gateway 23 grants speech item access in the direct-mode network, and forwards the granted speech item access request to the group communication system which then grants or rejects the request in a similar manner as the requests from other (cellular) members. Thus, although speech item is granted locally by the gateway 23, it may still be rejected on the system level by the group communication system 21. In another embodiment of the invention, a cellular service group communication agent that controls the speech item reservation within the direct-mode network resides in a terminal DT of a direct-mode network 24. In that case, the agent grants speech item to one of the group members in the direct-mode network, and then the speech item request is forwarded via the gateway 23 to the group communication system as described above.

There can be several gateway nodes 23 in a single direct-mode network. In that case, the gateway nodes can arbitrate the gateway functionality for certain local direct-mode network members based on a routing algorithm used in a multihop network. The arbitration may be based on a multihop dynamic routing algorithm or a lower dynamic configuration protocol of the shared media (e.g. WLAN). In the case of using TETRA DMO, the gateway 23 arbitrates the functionality in the case of several gateway nodes in the direct-mode operation (DMO) mode as described in the TETRA specifications.

Both permanent and ad hoc groups can be supported over the gateway 23. In the case of ad hoc groups, short message service (SMS) or intelligent message may be sent over a cellular access network in order to invite a new member to the cellular group. The gateway node 23 relays the invite message to the terminal DT to be invited using the cellular group communication agent in the terminal or using the messaging method used in the direct-mode network, such as short data service (SDS) message in the TETRA DMO.

In different embodiments of the invention, one or more of the following procedures may take place in the gateway 23:

configuration and dynamic re-configuration of the local direct mode network;

configuration of one of possible several gateway nodes to act as a gateway to certain groups and certain terminals in the direct-mode network;

gateway and optionally direct mode terminal authentication and registration to the cellular group communications service;

mapping of direct mode groups to the packet-based group communications service;

mapping of direct mode terminal one-to-one calls to packet-based group communications service calls;

direct-mode terminal invitation to an ad hoc group from a cellular group member, and a cellular terminal invitation to an ad hoc group from a direct mode group member;

terminal attachment to an ad hoc group and detachment from an ad hoc group;

speech item reservation in the direct-mode network and in the packet-based group communication service;

speech item routing between the direct-mode and cellular networks.

The operation of the basic invention will be now described by means of an implementation example wherein the direct-mode network is based on the TETRA DMO, and the TETRA DMO is used as specified in the TETRA specifications. The cellular packet-based group communication service 21 is a push-to-talk over cellular (PoC), and the gateway 23 extends the TETRA DMO group and individual communications to the PoC groups of the service 21. It is also assumed that all the PoC agent functionality reside in the gateway. In the following, the cellular access network 22 and the cellular group communication service are called with a common term “PoC network” and other (cellular) terminals are called “PoC terminals”. The gateway 23 may be implemented as TETRA DMO/GPRS/PoC gateway terminal. The direct-mode terminal DT may be a single-mode TETRA DMO terminal operating in a standard way according to the TETRA DMO standards.

The following sequence of actions may take place for a direct-mode terminal to become a PoC group member, to start listening the PoC group traffic, and to reserve speech item and to perform the talk spurt in the PoC group.

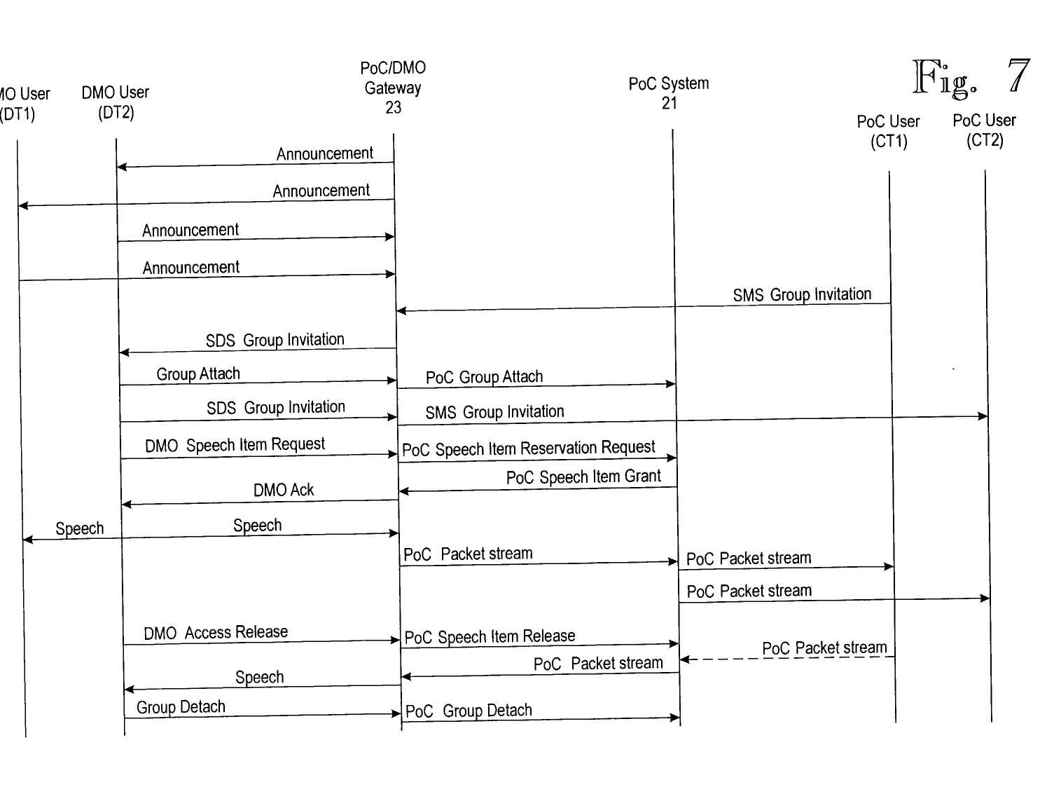

Referring now to FIG. 7, a dual mode PoC/DMO terminal assumes the role of a PoC/DMO gateway 23 by polling the presence of all DMO terminals within the range and by announcing the role of DMO gateway in accordance with the TETRA DMO standard, such as ETS 300 396-5, January 2000, Terrestrial Trunked Radio (TETRA); Technical requirements for Direct Mode Operation (DMO); Part 5: Gateway air interface.

A DMO terminal (such as DT2) announces to the DMO gateway 23, or the gateway 23 has the information of the DMO terminal in the DMO network 24.

In the case of (semi)permanent groups in the packet-based group communications service, the gateway registers and attaches to one or several of those (semi)permanent groups by 1) default or 2) initiated by taking the role of the gateway or 3) initiated by a DMO terminal (DT1) attaching to a direct-mode group. The gateway has a mapping between the direct-mode and packet-based (semi)permanent groups.

In the case of ad-hoc groups, a PoC group member (such as CT1) invites a DMO user (e.g. DT2) to a PoC group by sending a group invitation message (e.g. a short message SMS) addressed to the gateway. The access network 21 routes the group invitation SMS to the gateway 23 that identifies the DMO user from a sent URL containing the DMO address directly in the URL, or containing an identifier that the gateway 23 can convert into the address of the DMO terminal DT2. The gateway 23 stores the PoC group identifier (e.g. the URL) and the associated DMO terminal address and/or DMO group address. Then the gateway 23 creates the group invitation message (e.g. SDS) containing the DMO group address. Alternatively, gateway 23 may carry out a DMO group invitation as if the DMO user DT2 would be invited to a DMO group.

A DMO user (e.g. DT2) attaches to a PoC group through the PoC/DMO gateway 23. For example, the DMO user DT2 carries out a DMO group attach to the gateway 23. Upon receiving the group attach request, the gateway 23 identifies the DMO group address as one of the PoC group address URL address part directly, or the gateway 23 may map the DMO group address to a PoC group ULR address. The gateway 23 then attaches to the PoC group in accordance to the PoC group attach procedure using the address of the DMO terminal DT2. Therefore, in the PoC system 21 point of view, the procedure is as if the DMO user of DT2 would directly attach to the group. The operation of the PoC server system 21 may be as described in the co-pending patent applications mentioned above.

DMO user (e.g. DT2) can invite new member to the PoC group by sending a group invitation message (e.g. SDS) containing the address of the invited member (e.g. OPC user CT1). The gateway 23 converts the address to the PoC ad hoc group invitation message (e.g. SMS) and sends the invitation message over the cellular access network 22 to the invited member CT1. Basic procedure of this invitation procedure may be in accordance with the co-pending U.S. patent application Ser. No. 09/985,169 mentioned above.

A DMO terminal (e.g. DT2) reserves a speech item (a talk spurt) by assuming the master role in the DMO network 24 and waiting for an acknowledgement from the gateway 23. Upon receiving the DMO speech item request, the gateway 23 sends a PoC speech item reservation request to the PoC system 21. This request may be a separate request message, or it may be a leading packet (e.g. RTP) followed by the actual traffic packets. Examples of these procedures have been described in the co-pending applications mentioned above. The PoC system grants or rejects the speech item request. In the example shown in FIG. 7, the PoC system 21 acknowledges the PoC speech item grant to the gateway 23 that then acknowledges the DMO speech item request to the DMO user DT2 allowing it to start talking. Alternatively, the gateway 23 may send the DMO acknowledgement then it grants the speech item locally in the direct-mode network 24 and sends the PoC speech item reservation request to the PoC system 21. In that case PoC speech item grant acknowledgement may not be required. This is useful approach especially when the leading packet reservation request is utilized, because the speech can be started and the PoC packet stream can be sent immediately after the leading packet. In that case, only the rejection of the PoC speech item reservation request may be signalled to the gateway 23 from the PoC system 21. After the DMO terminal DT2 has received the DMO acknowledgement from the gateway 23, it starts the DMO speech item on the shared channel of the network 24. The transmitted speech signal is received by the gateway 23 and other members of the DMO group. The gateway 23 converts the DMO speech signal into a PoC packet stream (RTP packet stream) that is forwarded to the PoC system 21. The PoC system 21 multicast or multi-unicast the PoC packet stream to the other PoC users (e.g. CT1 and CT2) in the respective PoC group. Examples of the PoC user layer communication are described in the co-pending applications mentioned above.

When the DMO terminal (e.g. DT2) terminates the speech item (talk spurt), it may send a DMO access release message to the gateway 23. The gateway 23 converts the DMO message into a PoC speech item release message to be sent to the PoC system 21. The PoC release message may be a separate message, or it may be a specific trailer packet in the PoC packet stream. Upon receiving the PoC release message, the PoC ends the speech item. Examples of the procedures for ending a PoC speech item are disclosed in the co-pending applications mentioned above.

A DMO user (e.g. DT2) can depart from the PoC group by sending a DMO group detach message to the gateway 23. The gateway 23 converts the DMO message into a PoC user detach message that is sent to the PoC system 21. The DMO user is then removed from the PoC group in the PoC system 21.

Another example of the implementation is a PoC gateway for a local packet-based direct-mode network (an ad hoc network). For example, the other implementation may be a multihop/GPRS/PoC communication system having a PoC/WLAN or PoC/Bluetooth gateway 23 extending the PoC functionality to a multihop packet-based WLAN/Bluetooth network. In the case of a packet-based ad hoc or multihop network 24, the PoC agent (PoC functionality) can reside in the direct-mode terminal and the gateway 23 may act as a “proxy” for the direct-mode terminal towards the PoC system, emulating a number of PoC terminals from a single PoC gateway. In other words, the direct-mode terminal DT may be a single-mode WLAN/Bluetooth multihop packet terminal having the PoC agent software equivalent to that in the normal PoC terminal, such as CT1. As the gateway 23 may have limited capacity for the PoC traffic over the cellular air interface, it may generate speech item reject messages locally back to the requesting direct-mode terminals, if the gateway does not support multiple PoC talk groups simultaneously.

Examples of steps that may take place in this embodiment of the invention and in its modifications are given below. The signalling and traffic over the cellular air interface may be very similar to that shown in FIG. 7. Also the signalling and traffic within the direct-mode network may be very similar to that shown in FIG. 7, except that different messages may be used depending on the specific direct-mode network.

1). The gateway authenticates and registers on its own part, and also optionally on the part of the direct mode terminals in the ad-hoc network, to the packet-based group communications service at the moment it takes the role of a gateway. 2). The gateway attaches/detaches to one or several PoC (semi)permanent groups at the moment it takes the role of gateway operation or alternatively only by the initialization of a direct mode terminal at its request. 3). The gateway proceeds speech item requests to the PoC server and grants or rejects speech item requests from direct mode terminals locally based on its own resource of communications channels to the PoC server or based on the PoC server acknowledgement for speech items. 4). The gateway proxies control messages (e.g. SIP, H323, etc) from direct mode terminals to PoC server and vice versa 5). The gateway routes user plane (e.g. RTP, TCP) traffic to/from the PoC server to/from direct mode terminals. In the case of ad-hoc groups, the gateway converts group invitation message (e.g. SMS) from a PoC terminal (CT1) to a group invitation message (e.g. SIP, H323 etc) for a direct mode terminal (DT2). The group invitation SMS is sent from CT1 to the gateway as the gateway only has a cellular identity (e.g SIM identity). The gateway uses the group invitation (e.g. SMS message) URL to identify the direct mode terminal (DT2) and converts the group invitation URL in the group invitation (e.g. SMS message) to a group invitation URL for the group invitation message (e.g. SIP, H323 etc) for the direct mode terminal. The same procedure takes place also in the reverse direction where the direct mode terminal (DT2) invites a PoC terminal (CT1) to a group.

The description only illustrates some embodiments of the invention. The invention is not, however, limited to these examples, but it may vary within the scope and spirit of the appended claims.

What is claimed is:

1. A wireless communications system, comprising:
a cellular communications network having a cellular air interface for communication with cellular user terminals, and a packet-based group communication service;
a direct mode network including direct-mode user terminals capable of permitting communication directly between the direct-mode user terminals over a direct-mode air interface; and
a group communications gateway configured to communicate with the packet-based group communication service over the cellular air interface and with the direct-mode user terminals over the direct-mode air interface and to interchange at least one of group packet control signalling, group packet speech and data traffic, whereby enabling the direct-mode user terminals to participate in a packet-based cellular group communication.

2. A system according to claim 1, wherein the group communications gateway is configured to relay group attachments and group detachments from the direct-mode user terminals to a communication group in said packet-based group communication service.

3. A system according to claim 1, wherein the group communications gateway is configured to authenticate and register to said packet-based group communications service on behalf of the direct-mode user terminals.

4. A system according to claim 1, wherein the group communications gateway is configured to handle-speech item reservations from the direct-mode user terminals to a communication group in the packet-based group communication service.

5. A system according to claim 4, wherein the group communications gateway is configured to locally accept or reject speech item reservations from the direct-mode user terminals to a communication group in the packet-based group communication service and to send accepted speech item reservations to the packet-based group communication service.

6. A system according to claim 1, wherein the direct-mode user terminals communicate on a shared circuit-mode radio channel.

7. A system according to claim 1, wherein the direct-mode user terminals communicate with the group communications gateway according to a group or individual communication protocol of the direct mode network, and wherein the group communications gateway comprises a packet-mode group communication agent that emulates a respective number of cellular group members towards the packet-based group communication service in the cellular network.

8. A system according to claim 1, wherein the direct mode network comprises a packet-based ad-hoc network.

9. A system according to claim 1, wherein at least part of the direct-mode terminals comprise a packet-mode group communication agent, and wherein the group communications gateway comprises packet-mode group communication proxy emulating a respective number of cellular group members towards the packet-based group communication service in the cellular network.

10. A system according to claim 1, wherein the direct-mode terminal agent authenticates and registers to the packet-based group communications service.

11. A system according to claim 1, wherein at least one agent of a plurality of packet-mode group communication agents in the direct-mode user terminals is configured to locally accept or reject speech item reservations from the direct-mode user terminals to a communication group in the packet-based group communication service, and wherein the group communications gateway is configured to send accepted speech item reservations to the packet-based group communication service.

12. A system according to claim 1, wherein the direct-mode network comprises a multihop direct-mode network.

13. A system according to claim 1, wherein the direct-mode network comprises direct-mode terminals of a TETRA system.

14. A system according to claim 1, wherein the packet-based group communication service comprises a push-to-talk over cellular type group communication service.

15. A system according to claim 1, wherein the packet-based group communication service comprises a group communications IP server system overlaying the cellular communications network.

16. A direct mode network, comprising:
direct-mode user terminals capable of permitting communications between the direct-mode user terminals over a direct-mode air interface; and
a group communications gateway communicating with a packet-based group communication service in a cellular network over a cellular air interface and with the direct-mode user terminals over the direct-mode air interface for interchanging at least one of group and individual call control signalling, group packet speech and data traffic, whereby enabling the direct-mode user terminals to participate in a packet-based cellular group communication.

17. A network according to claim 16, wherein the direct-mode user terminals group and direct call control signalling is based on Session Initiation Protocol.

18. A network according to claim 16, wherein at least part of the direct-mode user terminals comprise a packet-mode group communication agent, and wherein the group communications gateway comprises packet-mode group communication proxy emulating a respective number of cellular group members towards the packet-based group communication service in the cellular network.

19. A network according to claim 16, wherein at least one agent of a plurality of packet-mode group communication agents in the direct-mode terminals is configured to locally accept or reject speech item reservations from the direct-mode user terminals to a communication group in the packet-based group communication service, and wherein the group communications gateway is configured to send accepted speech item reservations to the packet-based group communication service.

20. A network according to claim 16, wherein the group communications gateway is configured to locally accept or reject speech item reservations from the direct-mode user terminals to a communication group in the packet-based group communication service and to send accepted speech item reservations to the packet-based group communication service.

21. A wireless device, comprising:
means for communicating with direct-mode user terminals in a direct mode network over a direct-mode air interface, and
means for interchanging at least one of group control signalling, group packet speech and data traffic with a packet-based group communication service of a cellular communications network over a cellular air interface of the cellular communications network, whereby enabling the direct-mode user terminals to participate in a packet-based cellular group communication.

22. A device according to claim 21, further comprising at least one of the following:
means for relaying group attachments and group detachments from the direct-mode user equipments to a communication group in said packet-based group communication service;
means for controlling speech item reservations from the direct-mode user equipments to a communication group in the packet-based group communication service; and
means for routing at least one of group packet speech and data traffic between the direct-mode user equipments and the packet-based group communication service.

23. A device according to claim 21, further comprising means for locally accepting or rejecting speech item reservations from the direct-mode user terminals to a communication group in the packet-based group communication service and for sending accepted speech item reservations to the packet-based group communication service.

24. A device according to claim 21, wherein the device comprises a dual-mode terminal for cellular and direct-mode networks.
